(19) United States
(12) Patent Application Publication
(10) Pub. No.: US 2015/0135186 A1
(43) Pub. Date: May 14, 2015

(54) COMPUTER SYSTEM, METHOD AND COMPUTER-READABLE STORAGE MEDIUM FOR TASKS SCHEDULING

(71) Applicant: INSTITUTE FOR INFORMATION INDUSTRY, TAIPEI (TW)

(72) Inventors: Chun-Ting LIN, New Taipei City (TW); Cheng-Lin LEE, New Taipei City (TW); Yu-Te LIN, Kaohsiung City (TW); Jenq-Kuen LEE, Hsinchu City (TW); Wei-Ming CHIANG, New Taipei City (TW)

(73) Assignee: INSTITUTE FOR INFORMATION INDUSTRY, TAIPEI (TW)

(21) Appl. No.: 14/200,029

(22) Filed: Mar. 7, 2014

(30) Foreign Application Priority Data
Nov. 14, 2013 (TW) 102141466

(51) Int. Cl. G06F 9/46; G06F 9/50

(52) U.S. Cl. CPC G06F 9/46; G06F 9/5027
USPC 718/104; 718/102

(57) ABSTRACT

A computer system is provided. The computer system includes multiple computing devices and a processing unit. The processing unit comprises a device monitoring module, a task classifying module and a task scheduling module. The processing unit is coupled to the computing devices. The device monitoring module is configured to monitor the computing devices so as to obtain loading data. The task classifying module is configured to classify related tasks of multiple tasks as a first group, to classify independent tasks of multiple tasks as a second group and to find a critical path of the related tasks in the first group. The task scheduling module is configured to set a first processing schedule of the first group according to the critical path and the loading data and to set a second processing schedule of the second group according to the first processing schedule.

### RELATED APPLICATIONS

This application claims priority to Taiwan Application Serial Number 102141466, filed Nov. 14, 2013, which is herein incorporated by reference.

### BACKGROUND

1. Field of Invention

The present invention relates to a task scheduling method of a computer system. More particularly, the present invention relates to a task scheduling method of a heterogeneous multi-core computer system, and computer-readable storage medium thereof.

2. Description of Related Art

Recently, the physical limit of semiconductor products increases the cost and time of designing single-core processors. The processors of the computer systems such as mobile phones, tablets and personal computers are no longer asked for higher clock speed, instead, the trend now is toward the multi-core processor.

In the conventional practice, the multi-core processors can be sorted into homogeneous multi-core processors and heterogeneous multi-core processors. Since there are all kinds of different application programs, some of the application programs require the computation of high clock speed, and some of the application programs require parallel computation. Accordingly, when multiple of different kinds of application programs are processed, the heterogeneous multi-core processors are more advantageous over the homogeneous multi-core processors.

Therefore, coping with the development of the heterogeneous multi-core processor, application programming interface of open computing language (OpenCL) dealing with different types of cores is attached more importance.

However, developers of OpenCL programs need to develop different programs with respect to different types of multi-core processors. For example, developers need to develop different schedulers for different types of multi-core processors, which lowers the portability of the schedulers. Moreover, the schedulers nowadays do not take advantage of processing resource of the different processing devices in the heterogeneous multi-core processor such that the processing resource is not used efficiently.

### SUMMARY

A computer system is provided. The computer system includes multiple computing devices and a processing unit. The processing unit includes a device monitoring module, a task classifying module and a task scheduling module. The processing unit is coupled to the computing devices. The device monitoring module is configured to monitor the computing devices so as to obtain loading data. The task classifying module is configured to classify related tasks of multiple tasks as a first group, to classify independent tasks of the tasks as a second group and to find a critical path of the related tasks in the first group. The task scheduling module is configured to set a first processing schedule of the first group according to the critical path and the loading data and configured to set a second processing schedule of the second group according to the first processing schedule.

A scheduling method for a computer system is provided. The scheduling method includes the steps of: monitoring multiple computing devices so as to obtain loading data, classifying related tasks and independent tasks of multiple tasks as a first group and a second group respectively, setting a critical path of the first group, setting a first processing schedule of the first group according to the critical path and the loading data and setting a second processing schedule of the second group according to the first processing schedule of the first group and the loading data.

A non-transitory computer-readable medium storing a computer program for executing a scheduling method of a computer system is provided. The scheduling method includes the steps of: monitoring multiple computing devices so as to obtain loading data, classifying related tasks and independent tasks of multiple tasks as a first group and a second group respectively, setting a critical path of the first group, setting a first processing schedule of the first group according to the critical path and the loading data and setting a second processing schedule of the second group according to the first processing schedule of the first group and the loading data.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a schematic diagram of a computer system according to an embodiment of the present disclosure.

FIG. 2A illustrates a schematic diagram of one related-task group according to an embodiment of the present disclosure.

FIG. 2B illustrates a schematic diagram of another related ask group according to an embodiment of the present disclosure.

FIG. 2C illustrates a schematic diagram of one independent-task group according to an embodiment of the present disclosure.

FIG. 3 illustrates a schematic diagram of all tasks in one related-task group according to an embodiment of the present disclosure.

FIG. 4 illustrates a schematic diagram of all tasks in another related-task group according to an embodiment of the present disclosure.

FIG. 5A illustrates a schematic diagram of one related-task group and one independent-task group according to an embodiment of the present disclosure.

FIG. 5B illustrates a scheduling diagram of one related-task group and one independent-task group according to an embodiment of the present disclosure.

FIG. 6 illustrates a flow diagram of a scheduling method according to an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

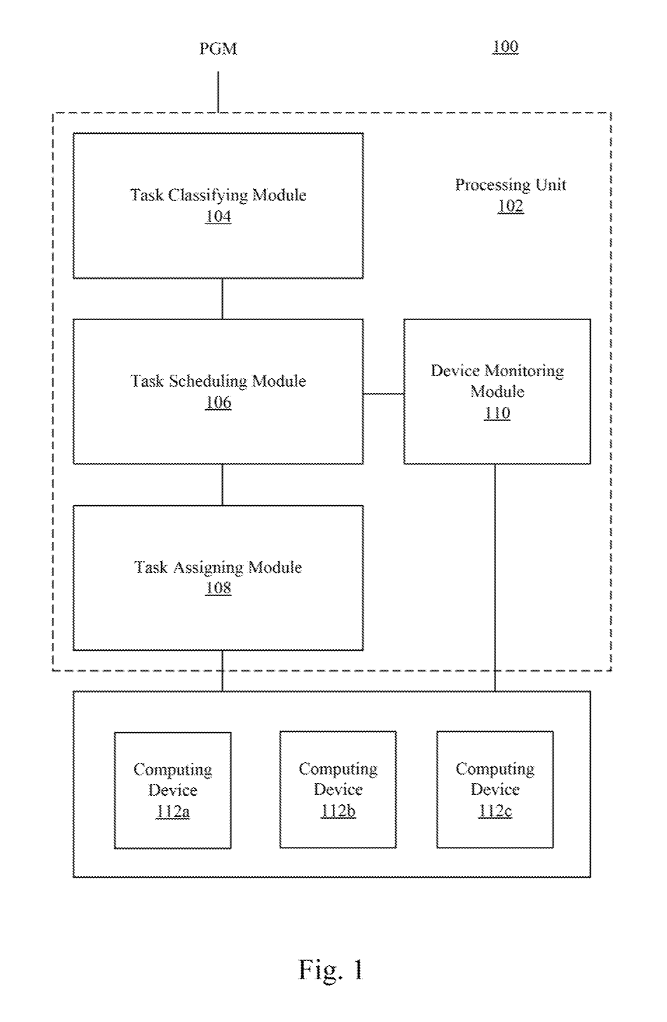

Reference is now made to FIG. 1, FIG. 1 illustrates a schematic diagram of a computer system 100 according to an embodiment of the present disclosure. The computer system 100 includes a processing unit 102 and a plurality of computing devices 112a-112c. The processing unit includes a task classifying module 104, a task scheduling module 106, a task assigning module 108 and a device monitoring module 110.

The processing unit 102 is coupled to the computing devices 112a-112c. In more details, the task assigning module 108 and the device monitoring module 110 of the processing unit 102 are coupled to the computing devices 112a-112c respectively. In the processing unit 102, the task classifying module 104 is coupled to the task scheduling module 106. The task scheduling module 106 is coupled to the device monitoring module 110 and the task assigning module 108.

The device monitoring module 110 monitors the computing device 112a-112c so as to obtain loading data of the computing device 112a-112c and output the loading data to the task scheduling module 106.

In some embodiments, each of the computing devices 112a-112c can be a central computing unit, a graphic processing unit or a cloud processing unit.

In some embodiments, a number of the computing devices is not restricted to 3.

First, the task classifying module 104 receives the program PGM and divides the program PGM into multiple tasks. Then, the task classifying module 104 classifies related tasks into a related-task group and classifies independent tasks of the program PGM into an independent-task group. To be more precisely, identifying the related tasks or the independent tasks is based on whether the tasks read/write the same address of the memory. If some of the tasks involve in reading/writing the same section, sector or address of the memory, the tasks are identified related and classified into the same related-task group. In contrast, if some of the tasks involve in reading/writing different sections, sectors or addresses of the memory, the tasks are identified independent and classified into one independent-task group.

A series of related tasks can be a related-task group in the computer system 100. On the other hand, there may exist multiple series of related tasks which can be classified into multiple different related-task groups.

In some embodiments, the related-task group can be named as a stateful group, and the independent task group can be named as a stateless group.

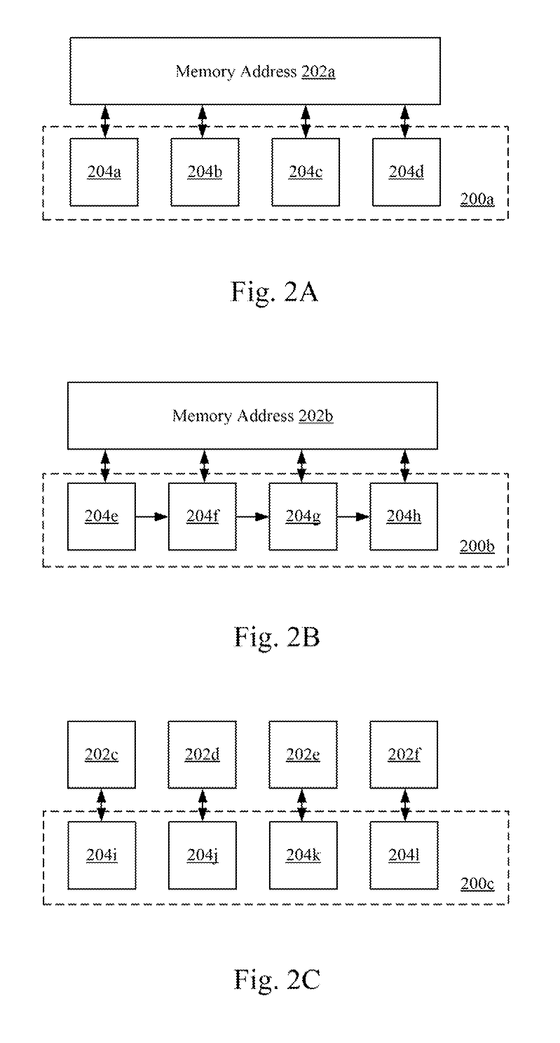

In order to explain the related-task group and the independent-task group in more details, reference is also made to FIGS. 2A-2C. FIGS. 2A-2B illustrate schematic diagrams of two kinds of related-task groups according to an embodiment of the present disclosure.

As shown in FIG. 2A, the task group 200a includes four tasks 204a-204d which read/write the same memory address 202a respectively. Therefore, the task group 200a is called a related-task group.

As shown in FIG. 2B, the task group 200b includes four tasks 204e-204h which read/write the same memory address 202a respectively. Therefore, the task group 200b is also called the related-task group. Compared with the task group 200a in FIG. 2A, the task group 200b has a processing order. other words, once the task 204e is finished, the task 204f begins to be processed. Similarly, the task 204g and the task 204h are processed continuously in the same way later on.

On the other hand, FIG. 2C illustrates a schematic diagram of one independent-task group according to an embodiment of the present disclosure. As shown in FIG. 2C, the task group 200c includes four tasks 204i-204l which read/write different memory addresses 202c-202f. Therefore, the tasks 204i-204l are called an independent-task group.

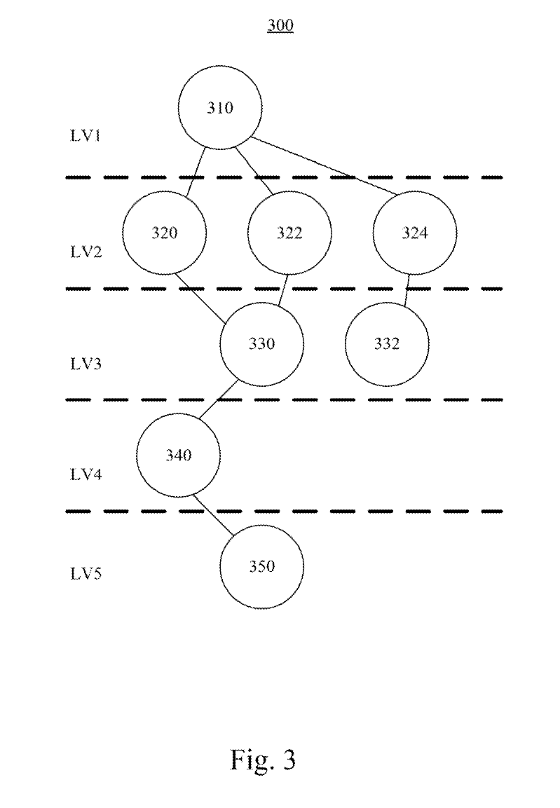

Moreover, the task classifying module 104 is further configured to find a critical path of the related-task group. The critical path is a sequence of tasks having a longest processing time length of the related-task group and can determine a total processing time length of all the tasks. To be more precise, reference is made to FIG. 3. FIG. 3 illustrates a schematic diagram of all tasks in one related-task group 300 according to an embodiment of the present disclosure. The related-task group 300 includes tasks 310, 320, 322, 324, 330, 332, 340 and 350.

First of all, the task classifying module 104 classifies the tasks 310, 320, 322, 324, 330, 332, 340 and 350 into five levels LV1-LV5 according to a processing order of the tasks. Since the levels LV2-LV5 to which the tasks 320, 322, 324, 330, 332, 340 and 350 belong respectively are after the level LV1 in order, the tasks 320, 322, 324, 330, 332, 340 and 350 are called successor tasks of the task 310. On the other hand, since level LV2 to which the tasks 320, 322 and 324 belong is a next level of level LV1 in order, the tasks 320, 322 and 324 are called immediate successor tasks.

Since the level LV1 only includes the task 310, the task classifying module 104 sets the task 310 as an initial task. Starting from the initial task, i.e., the task 310, the task classifying module 104 finds a critical path level by level. The task classifying module 104 selects a critical immediate successor task from the immediate successor tasks 320, 322, 324. In the present embodiments, a selection parameter for the critical immediate successor task is processing time lengths of each immediate successor task in each of the computing devices 112a-112c. Here, since the task 320 has the longest processing time length on each of the computing devices 112a-112c among the immediate successor tasks 320, 322, 324, the task 320 is selected as the critical immediate successor task. The processing time length further includes time of moving data from/to the memory. For example, if the task 310 and the task 320 are allocated to the computing device 112a and the computing device 112b respectively, data stored in the computing device 112a is moved to the computing device 112b for the task 320 to use. Then, the tasks 330, 340 and 350 are selected in levels LV3-LV5 such that tasks 310, 320, 330, 340 and 350 are the critical path of the related-task group 300. And the task classifying module 104 transmits the critical path to the task scheduling module 106.

In some embodiments of the present disclosure, the selection parameter can be a total processing time length of the immediate successor tasks, in which the total processing time length corresponds to each immediate successor task processed in one of the computing devices 112a-112c. For example, the total processing time is the shortest if the tasks 310 and 320 are allocated to the computing device 112a, the task 322 is allocated to the computing device 112b, and the task 324 is allocated to the computing device 112c, in which the task 320 has the longest processing time length in the computing device 112a. Thus, The task 320 is selected as the critical immediate successor task.

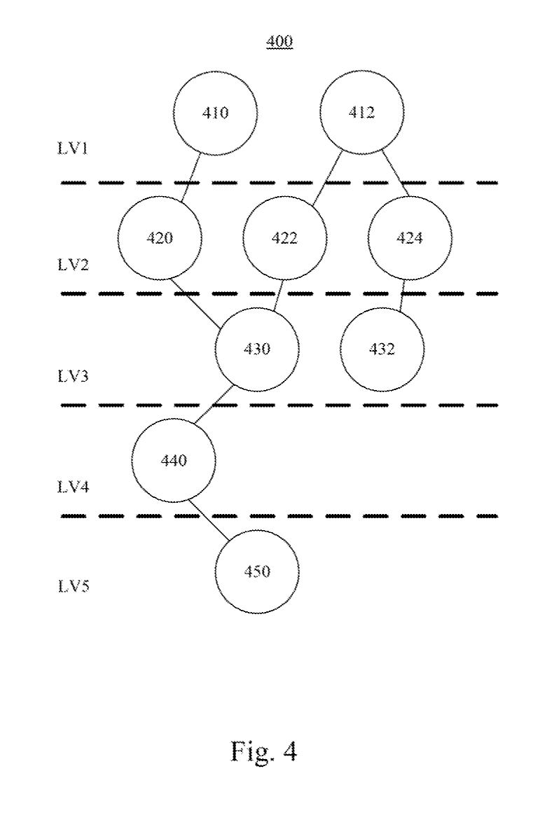

In some embodiments, the selection parameter can be a number of the successor tasks of the immediate successor tasks. To be more precise, reference is now made to FIG. 4. FIG. 4 illustrates a schematic diagram of all tasks in another related-task group 400 according to an embodiment of the present disclosure. The related-task group 400 includes tasks 410, 412, 420, 422, 424, 430, 432, 440 and 450. The task classifying module 104 classifies the tasks 410, 412, 420, 422, 424, 430, 432, 440 and 450 into five levels LV1-LV5.

Compared to the related-task group 300 in FIG. 3, the related-task group 400 has two tasks in level LV1. The task classifying module 104 can set the initial task according to the selection parameter. Since the selection parameter in the present embodiment is the number of the successor tasks of the immediate successor task. When the initial task is selected among the tasks 410, 412 in the level LV1 according to the selection parameter, the initial task is selected according to number of the successor tasks of the tasks 410, 412 in the level LV1. Therefore, as shown in FIG. 4, the number of the successor tasks of the task 410 is 4, and the number of the successor tasks of the task 412 is 6. Thus, the initial task is set to be the task 412 having more successor tasks.

Next, the immediate successor tasks of task 412 in level LV2 are tasks 422 and 424, the number of the successor tasks of the task 422 is 3, and the number of the successor task of the task 424 is 1. Therefore, the task 422 is selected as a critical immediate successor task. Afterwards, the tasks 430, 440 and 450 are selected as critical immediate successor tasks such that the critical path is obtained and transmitted to the task scheduling module 106.

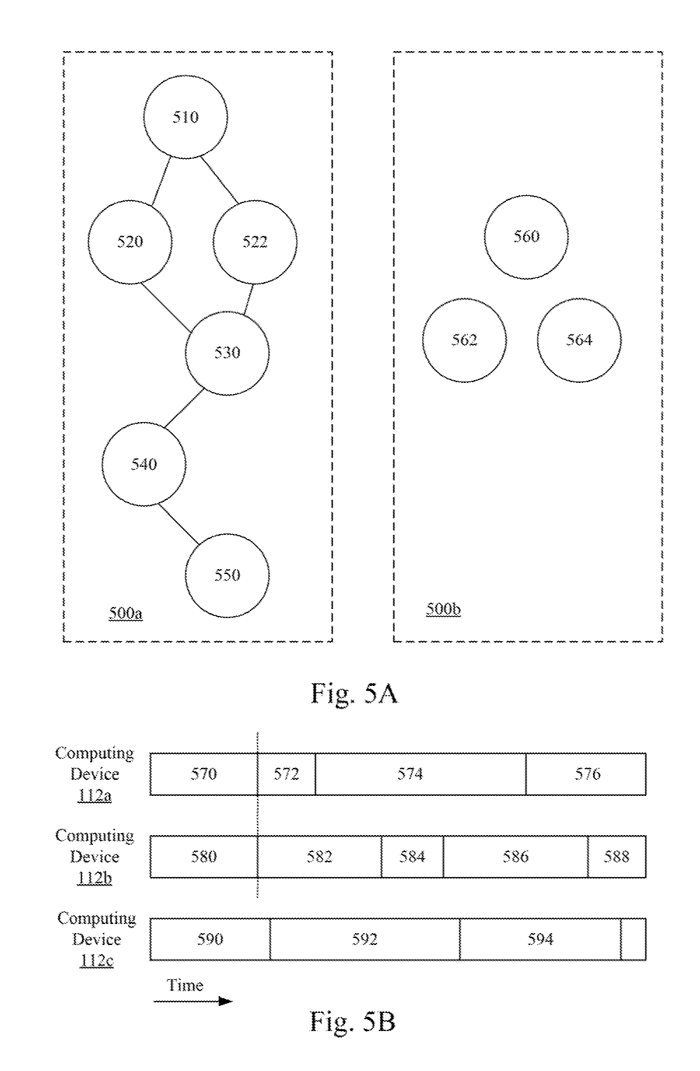

The tasks scheduling module 106 is configured to set a first processing schedule of the related-task group according to the critical path and the loading data and to set a second processing schedule according to the first processing schedule and the loading data of the computing devices 112a-112c. To be more precise, references are made to FIG. 5A and FIG. 5B. FIG. 5A illustrates a schematic diagram of one related-task group and one independent-task group according to an embodiment of the present disclosure. FIG. 5B illustrates a scheduling diagram of one related-task group and one independent-task group according to an embodiment of the present disclosure.

As shown in FIG. 5A, related-task group 500a includes tasks 510, 520, 522, 530, 540 and 550, and independent-task group 500b includes tasks 560, 562 and 564. A critical path of the related-task group 500a is tasks 510, 520, 530, 540 and 550. The computing devices 112a, 112b and 112c are a central processing unit, an image processing unit and a cloud processing unit respectively.

In the present embodiment, the related-task group 500a includes tasks 510, 520, 530, 540 and 550 requiring large parallel computation and task 522 requiring high-speed computation. The independent-task group 500b includes tasks 560, 562, 564 requiring high-speed computation.

In order to explain how the task scheduling module 106 sets the schedule, reference is also made to FIG. 5B. As shown in FIG. 5B, since time interval 590 is already occupied by other programs or other users according to the loading data, the scheduling module 106 does not allocate any task into the time interval 590.

First, the task scheduling module 106 starts to schedule from the related-task group 500a. In all the tasks of the related-task group 500a, the task 510 of the first level is first scheduled. Since the task 510 involves in large parallel computation, a processing time length of the task 510 in the image processing unit 112b is shorter than a processing time length of the task 510 in the central processing unit 112a, in which the task scheduling module 106 computes the processing time lengths. In addition, the cloud processing unit is not available at the same time. Accordingly, the task 510 is allocated into time interval 580 of the computing device 112b.

In the next level, the task scheduling module 106 first schedules the task 520 on the critical path. Since the task 520 also involves in large parallel computation, task scheduling module 106 also allocates the task 520 to the same image processing unit 112b so as to obtain a shorter processing time length, which makes the task 520 be allocated into a time interval 582. Then, the task scheduling module 106 further compares processing time lengths of the remaining task 522 in the same level, in which the processing time lengths (including the time of moving the data from/to the memory) correspond to the task 522 in the central processing unit 112a and the cloud processing unit 112c. Since speed of moving the data written by the task 510 to the central processing unit 112a is faster than the speed of moving the data written by the task 510 to the cloud processing unit 112c, the processing time length of the task 522 in the central processing unit 112a is shorter than the processing time length of the task 522 in the cloud processing unit 112c. Thus, the task 522 is allocated into time interval 572 of the central processing unit 112a. And the tasks 530, 540 and 550 involving in large parallel computation are allocated to the same image processing unit 112b so as to obtain a shorter processing time 584, 586, 588 respectively. Thereby, the first processing schedule of the related task group 500a is obtained.

After the task scheduling module 106 schedules the related-task group 500a, the task scheduling module 106 first computes and sorts the processing time lengths of individual tasks 560, 562 and 564 processed in the central processing unit 112a, image processing unit 112b and cloud processing unit 112c respectively. In the present embodiment, the descending order of the processing time lengths of the tasks 560, 562, 564 on each of the computing devices 112a-112c are the entire task 564, the task 562 and the task 560.

Afterwards, the task scheduling module 106 allocates tasks 560, 562, 564 of the independent-task group 500b according to the first processing schedule and the loading data, in which the first processing schedule includes the time intervals 572, 580, 582, 584, 586, 588, and the loading data includes the time interval 590.

In more details, the task scheduling module 106 sets a plurality of idle time intervals of the computing devices 112a-112c according to the first processing schedule and the loading data. And the task scheduling module 106 compares a time length of one of the idle time intervals with processing time lengths of the tasks 560, 562 and 564 so as to search for target tasks, in which a processing time length of the target task is smaller than the time length of the one of the idle time intervals. In addition, the processing time length of the target task is the closest to the time length of the one of the idle time intervals.

In the present embodiment, the task scheduling module 106 considers a first idle time interval 570 before the time interval 572 corresponding to the task 522 in the central processing unit 112a, and a time length of the time interval 570 is smaller than a time length of the processing time of each task 560, 562, 564 in the central processing unit 112a. Therefore, the first idle time interval 570 is withdrawn.

Next, the task scheduling module 106 considers a second idle time interval after the time interval 572 corresponding to the task 522 in the central processing unit 112a. Since time length of the second idle time interval is only greater than a processing time length of the task 560 in the central processing unit 112a, the task 560 is allocated to the central processing unit 112a.

Afterwards, the task scheduling module 106 considers a third idle time interval which is after the time interval 590 of the cloud processing unit 112c. Since a time length of the third idle time interval is greater than a total processing time length of the tasks 562 and 564 in the cloud processing unit 112c, the tasks 564, 562 are allocated into the time interval 592, 594 in order according to the lengths of the processing times of the tasks 564, 562. Thereby, the second processing schedule is obtained, in which the second processing schedule occupies the time intervals 574, 592 and 594.

As a result, task assigning module 108 assigns the tasks to the computing devices 112a-112c so as to execute the program PGM.

In all the above embodiments, the processing unit 102 can be a central processing unit, a control unit, a microprocessor or other hardware components which can execute commands of the program PGM.

Each module 104, 106, 108 and 110 can be implemented as programming codes, and the programming codes can be stored in a storage component. Accordingly, the processing unit reads and executes the programming codes of the storage component. In some embodiments, the storage component can be read-only memory, flash memory, soft disk, hard disk, compact disk, USB drive, magnetic tape, database accessed by the Internet or other types of storage components.

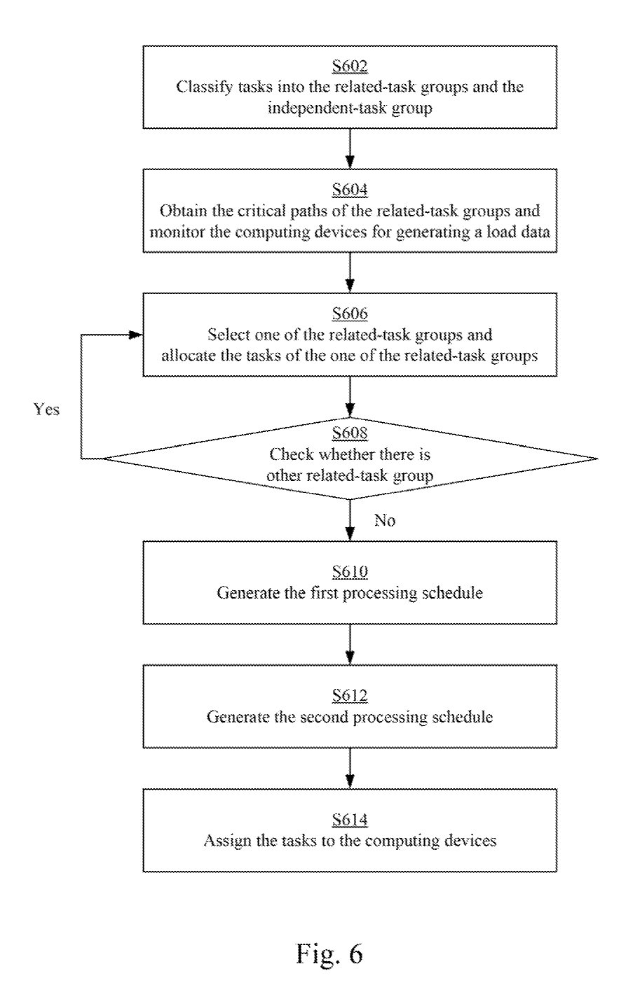

In order to clarify the flow of scheduling, reference is also made to FIG. 6. FIG. 6 illustrates a flow diagram of a scheduling method according to an embodiment of the present disclosure. First, when a program PGM is entered in the computer system 100, the task classifying module 104 of the processing unit 102 first analyzes the program PGM so as to classify tasks of the program PGM into the related-task groups and the independent-task group (S602). Then, the task classifying module 104 obtains the critical paths of the related-task groups and transmits the critical paths to the task scheduling module 106. In the meanwhile, the device monitor module 110 monitors the computing devices 112a-112c so as to generate the loading data to the task scheduling module 106 (S604). Afterwards, the task scheduling module 106 selects one of the related-task groups and allocates the tasks of the one of the related-task groups level by level according to the critical path of the one of the related-task groups and the loading data. In each level, the task scheduling module 106 first allocates the task of the critical path first and then allocates the remaining tasks (S606). Then, task scheduling module 106 checks whether there is other related-task group (S608). If there is other related-task group, the flow goes back to step S606 so as to schedule the other related-task group. If there is no other related-task group, the first processing schedule of the related-task groups is generated (S610). The tasks scheduling module 106 then finds idle time intervals of each computing device according to the first processing schedule and the loading data. The tasks scheduling module 106 allocates all tasks of the independent task group into the idle time intervals so as to generate the second processing schedule (S612). At last, the task assigning module assigns the tasks to the computing devices 112a-112c according to the first processing schedule and the second processing schedule so as to execute the program PGM (S614).

In some embodiments, the scheduling method shown in FIG. 6 can be implemented as a computer program product, e.g., application programs, and stored in a computer-readable memory. The computer can read computer-readable memory so as to execute the scheduling method. The computer-readable memory can be read-only memory, flash memory, soft disk, hard disk, compact disk, USB drive, magnetic tape, database accessed by the internet or other types of computer-readable memory known by the people skilled in the art.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A computer system, comprising:
a plurality of computing devices; and
a processing unit coupled to the computing devices, wherein the processing unit comprises:
a device monitoring module configured to monitor the computing devices so as to obtain loading data;
a task classifying module configured to classify related tasks of a plurality of tasks as a first group, configured to classify independent tasks of the plurality of tasks as a second group, and configured to find a critical path of the related tasks in the first group; and
a task scheduling module configured to set a first processing schedule of the first group according to the critical path and the loading data, and configured to set a second processing schedule of the second group according to the first processing schedule.

2. The computer system as claimed in claim 1, wherein the task classifying module is configured to identify the related tasks according to whether the tasks use a same memory address, wherein when a portion of the tasks read or write the same memory address, the portion of the tasks are classified as the first group.

3. The computer system as claimed in claim 1, wherein the task classifying module further divides the related tasks of the first group into a plurality of levels having a processing order and sets an initial task in a first level of the levels.

4. The computer system as claimed in claim 3, wherein the task classifying module starts from the initial task and selects a critical immediate successor task from at least one immediate successor task in a next level according to a selection parameter, and the task classifying module selects the critical immediate successor task of each level until a last level of the levels so as to obtain the critical path.

5. The computer system as claimed in claim 4, wherein the selection parameter is selected from a group consisting of a total processing time length corresponding to the immediate successor task in one of the computing devices, a number of the successor tasks of the immediate successor tasks, a plurality of processing time lengths of the immediate successor task in the computing devices, and the combination thereof.

6. The computer system as claimed in claim 3, wherein the task scheduling module schedules the tasks from the first level to a last level of the levels, and the scheduling module allocates a task corresponding to the critical path prior to allocating remaining tasks in each level.

7. The computer system as claimed in claim 6, wherein the task scheduling module sets a plurality of idle time intervals of the computing devices according to the first processing schedule and the loading data, and allocates the tasks of the second group into the idle time intervals.

8. The computer system as claimed in claim 7, wherein the task scheduling module is further configured to compute a plurality of processing time lengths corresponding to each of the independent tasks in the computing devices, and configured to compare a time length of one of the idle time intervals and the processing time lengths so as to search for a target task, wherein a processing time length of the target task is less than the time length of the one of the idle time intervals and is the closest to the time length of the one of the idle time intervals among a portion of the processing time lengths that are less than the length of the one of the idle time intervals.

9. The computer system as claimed in claim 1, wherein the computing devices are selected from a group consisting of a central processing unit, an image processing unit, a cloud processing unit, and the combination thereof.

10. The computer system as claimed in claim 1, wherein the computer system further comprises a task assigning module configured to assign the tasks to the computing devices according to the first processing schedule and the second processing schedule.

11. A scheduling method for a computer system, comprising:
monitoring a plurality of computing devices so as to obtain loading data;
classifying related tasks and independent tasks of a plurality of tasks as a first group and a second group respectively;
setting a critical path of the first group;
setting a first processing schedule of the first group according to the critical path and the loading data; and
setting a second processing schedule of the second group according to the first processing schedule of the first group and the loading data.

12. The scheduling method as claimed in claim 11, wherein the step of classifying the tasks into the first group and the second group further comprises:
classifying the tasks according to whether the tasks are using a same memory address, wherein a portion of the tasks are classified as the first group when the portion of the tasks read or write the same memory address.

13. The scheduling method as claimed in claim 11, wherein the step of classifying the tasks as the first group and the second group further comprises:
dividing the tasks of the first group into a plurality of levels having a processing order; and
setting an initial task in a first level of the levels.

14. The scheduling method as claimed in claim 13, wherein the step of setting the critical path of the first group further comprises:
selecting a critical immediate successor task from at least one immediate successor task in a next level according to a selection parameter from the initial task in the first level to a last level of the levels so as to find the critical path.

15. The scheduling method as claimed in claim 14, wherein the selection parameter is selected from a group consisting of a total computation time length corresponding to the immediate successor task in one of the computing devices, a number of the successor tasks of the immediate successor task, a plurality of processing time lengths of the immediate successor task in the computing devices, and the combination thereof.

16. The scheduling method as claimed in claim 13, wherein the step of setting the first processing schedule of the first group further comprises:
scheduling the tasks from a first level to a last level of the levels, wherein the tasks corresponding to the critical path is allocated prior to the remaining tasks being allocated in each level.

17. The scheduling method as claimed in claim 13, wherein the step of setting the second processing schedule of the second group comprises:
setting a plurality of idle time intervals according to the first processing schedule and the loading data; and
allocating the tasks of the second group into the idle time intervals.

18. The scheduling method as claimed in claim 16, wherein the step of scheduling the independent tasks of the second group into the idle time intervals further comprises:
computing a plurality of processing time lengths of the independent tasks of the second group;
comparing a time length of one of the idle time intervals and the processing time lengths so as to search for a target task;
wherein a processing time length of the target task is less than the time length of the one of the idle time interval and is the closest to the time length of the one of the idle time intervals among a portion of the processing time lengths which are less than the time length of the one of the idle time intervals.

19. The scheduling method as claimed in claim 11, wherein the scheduling method further comprises:
assigning the tasks to the computing devices according to the first processing schedule and the second processing schedule.

20. A non-transitory computer-readable medium storing a computer program for executing a scheduling method of a computer system, wherein the scheduling method of the computer system comprises:
monitoring a plurality of computing devices so as to obtain loading data;
classifying related tasks and independent tasks of a plurality of tasks a first group and a second group respectively;
setting a critical path of the first group;
setting a first processing schedule of the first group according to the critical path and the loading data; and
setting a second processing schedule of the second group according to the first processing schedule of the first group and the loading data.
